(19) United States
(12) Patent Application Publication
(10) Pub. No.: US 2025/0330928 A1
(43) Pub. Date: Oct. 23, 2025

(54) PARALLEL MEASUREMENT GAP ENHANCEMENT IN NON-TERRESTRIAL NETWORKS

(71) Applicant: Apple Inc., Cupertino, CA (US)

(72) Inventors: Jie Cui, San Jose, CA (US); Yang Tang, San Jose, CA (US); Yuqin Chen, Beijing (CN); Qiming Li, Beijing (CN); Yuexia Song, Beijing (CN); Fangli Xu, Beijing (CN); Xiang Chen, Palo Alto, CA (US); Dawei Zhang, Saratoga, CA (US); Hong He, San Jose, CA (US); Chunxuan Ye, San Diego, CA (US)

(21) Appl. No.: 19/110,134

(22) PCT Filed: Sep. 30, 2022
(86) PCT No.: PCT/CN2022/123407

§ 371 Date: Mar. 10, 2025

(51) Int. Cl. H04W 56/00; H04B 7/06; H04W 8/22; H04W 84/06

(52) U.S. Cl. CPC H04W 56/0015; H04B 7/0626; H04W 8/22; H04W 84/06

(57) ABSTRACT

Techniques described herein include solutions for configuring and using parallel measurement gaps with the same gap type for both synchronization signal block (SSB) based and channel state information reference signal (CSI-RS) based measurements associated to the same frequency layer. A User Equipment (UE) may indicate its capability to support parallel measurement gaps to a non-terrestrial base station. The capability may be indicated individually for SSB based and CSI-RS based measurements, or in a combined format for both SSB based and CSI-RS based measurements. The UE receives a measurement gap configuration to configure the parallel measurement gaps and performs measurements accordingly. The measurement gaps for SSB based measurements and the measurement gaps for CSI-RS based measurements may be considered as associated to the same or different frequency layers depending on various conditions.

### FIELD

This disclosure relates to wireless communication networks including techniques for performing measurements within wireless networks.

### BACKGROUND

Wireless communication networks may include user equipments (UEs), base stations, and/or other types of wireless devices capable of communicating with one another. During operation, a UE may measure signal quality of an active cell and/or neighboring cells to facilitate handover, carrier aggregation, and so on for enhanced performance.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) configured with parallel measurement gaps by a non-terrestrial network (NTN) in accordance with some aspects of the present disclosure.

FIG. 2 is a schematic diagram illustrating signaling between a UE and a non-terrestrial base station to configure parallel measurement gaps in accordance with some aspects of the present disclosure.

FIG. 3 is a block diagram illustrating a synchronization signal block (SSB) parallel measurement capability parameter and a channel state information reference signal (CSI-RS) parallel measurement capability parameter in accordance with some aspects of the present disclosure.

FIGS. 4A-4B are schematic diagrams illustrating parallel measurement gap configurations in accordance with some aspects of the present disclosure.

FIG. 5 is a schematic diagram illustrating a parallel measurement gap configuration in accordance with some aspects of the present disclosure.

FIG. 6 is a block diagram illustrating a combined parallel measurement capability parameter in accordance with some aspects of the present disclosure.

FIG. 7-9 are schematic diagrams illustrating a parallel measurement gap configurations in accordance with some aspects of the present disclosure.

FIG. 10-13 are schematic diagrams illustrating measurement gap prioritization in accordance with some aspects of the present disclosure.

FIG. 14 is a process flow for a UE to perform measurements using parallel measurement gaps in accordance with some aspects of the present disclosure.

FIG. 15 is a process flow for a base station to configure a UE for measurement using parallel measurement gaps in accordance with some aspects of the present disclosure.

FIG. 16 is a process flow for a UE to perform measurement gap prioritization for parallel measurement gaps in accordance with some aspects of the present disclosure.

FIG. 17 is a block diagram illustrating a device that can be employed to perform gapless UE measurements in accordance with some aspects of the present disclosure.

FIG. 18 is a block diagram illustrating baseband circuitry that can be employed to perform gapless UE measurements in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A user equipment (UE) may measure signal quality of an active cell and/or neighboring cells within a non-terrestrial network (NTN) to facilitate resource allocation procedures such as handover, beam management, etc. As an example, in 5G, synchronization signal blocks (SSBs) are used to determine path loss and average channel quality. Channel status information reference signal (CSI-RS) are used for tracking rapidly changing channel conditions to support mobility and beam management. Some examples of UE measurements using either SSB or CSI-RS include reference signal received power (RSRP), reference signal received quality (RSRQ), and signal to interference and noise ratio (SINR) measurements. The UE may perform a given measurement within a measurement gap, which may be configured by a serving base station. During the measurement gap, the UE suspends data transmission/reception and performs any necessary radio frequency (RF) circuitry retuning in order to perform the configured measurements.

The NTN may comprise a plurality of non-terrestrial base stations (e.g., satellites) capable of communicating with the UE. Due to the nature of NTNs, the base stations often move at very high speeds. Furthermore, non-terrestrial base stations are typically located further from the UE than terrestrial base stations. The far distance from the UE to the non-terrestrial base station introduces signaling latency, and the high moving speed introduces variability to said latency. Due to the unique challenges of NTN measurements, alternative measurement techniques are desired compared to their terrestrial counterparts, in order to reduce the time needed to complete measurements and improve measurement accuracy.

One of the measurement techniques that benefits the NTN or other long-distance base stations is to use two parallel measurement gaps for two or more NTN measurements that are defined as associated to one frequency layer. The two parallel measurement gaps share a measurement gap repetition period (MGRP) and are temporally offset from each other. Part of the continuing optimization of NTN is to enable parallel measurement gaps for CSI-RS measurements. Currently, it is unclear whether and when one or more CSI-RS measurements can use parallel measurement gaps, i.e., be considered as associated with one frequency layer with another CSI-RS measurement or even other UE measurements such as one or more SSB measurements. Furthermore, if parallel measurement gaps are configured for SSB based and CSI-RS based measurements but the measurement gaps are not compatible for simultaneous operation (e.g., exceeding UE capability, overlapping temporally, etc.), it is unclear which measurement gaps should be prioritized.

Accordingly, the present disclosure relates to configuration and prioritization of parallel measurement gaps for both SSB based and CSI-RS based NTN measurements. In some aspects, a UE transmits UE capability information to a non-terrestrial base station. The capability information indicates whether the UE supports two parallel measurement gaps with the same gap type for SSB based and CSI-RS based measurements associated to a single frequency layer. Based on the UE capability information, the non-terrestrial base station or the UE may prioritize measurements based on priority rules specified below, and the non-terrestrial base station may configure the UE with the measurement gaps associated with the prioritized measurements. Depending on if SSB, CSI-RS, or both SSB and CSI-RS measurements are configured, whether various measurements are associated with one frequency layer may be defined and determined based on different criteria.

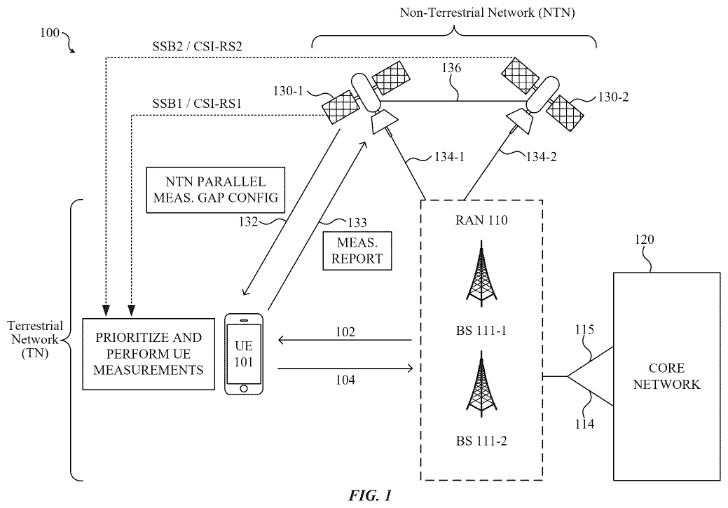

FIG. 1 illustrates an example architecture of a network system 100 in accordance with various aspects. The network system 100 includes a UE 101, which may represent one or more UEs (referred to collectively as “UEs 101” and individually as “UE 101”). The UE 101 may be configured to connect, for example, communicatively couple, with an NTN. The NTN may include non-terrestrial base stations (e.g., satellites) 130-1, 130-2. The UE 101 may communicate with the non-terrestrial base stations 130-1, 130-2 using connections 132 and 133 for downlink and uplink respectively. The non-terrestrial base stations 130-1, 130-2 may communicate with a radio access network (RAN) 110 using connections 134-1 and 134-2 respectively, and with each other using connection 136 or through the RAN 110 using connections 134-1 and 134-2. The RAN 110 may be part of a terrestrial network (TN) and may comprise one or more terrestrial base stations 111-1, 111-2, which may communicate with the UE using connections 102 and 104.

In some aspects, the UE 101 receives references signals from non-terrestrial base stations 130-1, 130-2 including SSB beams and CSI-RS, and performs the SSB/CSI-RS measurements using the configured parallel measurement gaps. The UE sends a measurement report to the non-terrestrial base station 130-1 including results of the measurements using connection 133.

In some aspects, the non-terrestrial base station 130-1 (e.g., a serving cell) sends a measurement configuration to the UE 101 to configure two parallel measurement gaps for NTN measurement. In some aspects, the measurement configuration is sent using connection 132. The parallel measurement gap types have the same gap type and are used for measurements associated with the same frequency layer. The gap type may, for example, include a per UE gap type, per frequency layer 1 (FR1) gap type, or per frequency layer 2 (FR2) gap type. Parallel measurement gaps share a MGRP, and the parallel measurement gaps may have the same or different gap patterns. The parallel measurement gaps may be used for SSB based measurements, CSI-RS based measurements, or a combination of SSB based and CSI-RS based measurements.

In some aspects, the measurement configuration configures more measurement gaps than the UE 101 is capable of supporting. In response, the UE 101 prioritizes configured measurement gaps within the capability of the UE 101 and drops other measurements associated with excessive measurement gaps based on a priority rule. The prioritization may include prioritizing measurement gaps for SSB based measurements, or prioritizing measurement gaps for an associated SSB measurement and the corresponding CSI-RS measurement. The associated SSB specifies timing information to be used for the corresponding CSI-RS, and may be specified by a parameter such as associatedSSB within a CSI-RS information element (IE) (e.g., CSI-RS-CellMobility).

In this example, the UEs 101 are illustrated as smartphones, but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system.

In some aspects, the core network (CN) 120 can be a 5GC (referred to as “5GC 120” or the like), and the RAN 110 can be connected with the CN 120 via two parts, a Next Generation (NG) user plane (NG-U) interface 114, which carries traffic data between the RAN nodes and a User Plane Function (UPF), and the SI control plane (NG-C) interface 115, which is a signaling interface between the RAN nodes and Access and Mobility Management Functions (AMFs).

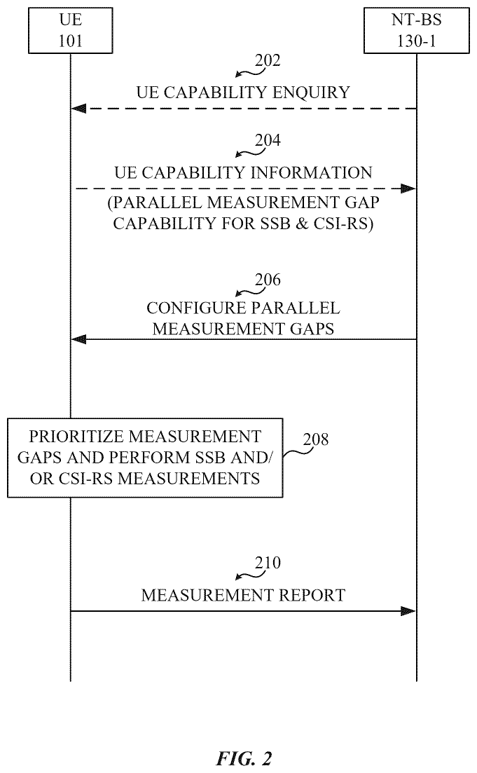

FIG. 2 illustrates signaling between a UE 101 and a non-terrestrial base station 130-1 to configure parallel measurement gaps in accordance with some aspects. In some aspects, the non-terrestrial base station 130-1 sends a measurement gap configuration 206 to the UE 101 to configure a set of parallel measurement gaps. The measurement gap configuration 206 may be sent using radio resource control (RRC) signaling or the like.

In some aspects, in response, the UE 101 performs various measurements using the configured parallel measurement gaps at act 208. If the parallel measurement gaps exceed UE capability (e.g., if the UE 101 only supports two parallel measurement gaps and the measurement configuration specifies three parallel measurement gaps), then the UE 101 may prioritize a sub-set of the configured measurement gaps (e.g., the UE 101 prioritizes two measurement gaps of the configured measurement gaps). The UE 101 then performs SSB and/or CSI-RS measurements using the prioritized measurement gaps and sends measurement report 210 to the non-terrestrial base station 130-1 including results of the SSB and/or CSI-RS measurements. Techniques for measurement gap prioritization are described in more detail further in the present disclosure.

In some optional aspects, the UE 101 receives a UE capability enquiry 202 before receiving the measurement gap configuration 206. In turn, the UE 101 sends UE capability information 204 to the non-terrestrial base station 130-1. In some aspects, the measurement configuration 206 is based on the UE capability information 204. The UE capability information 204 may be included in an IE (e.g., MeasAndMobParameters) and indicates if the UE 101 supports two parallel measurement gaps with the same gap type associated to one frequency layer. The indication may be made individually for SSB based and CSI-RS based measurements, or jointly for both SSB based and CSI-RS based measurements.

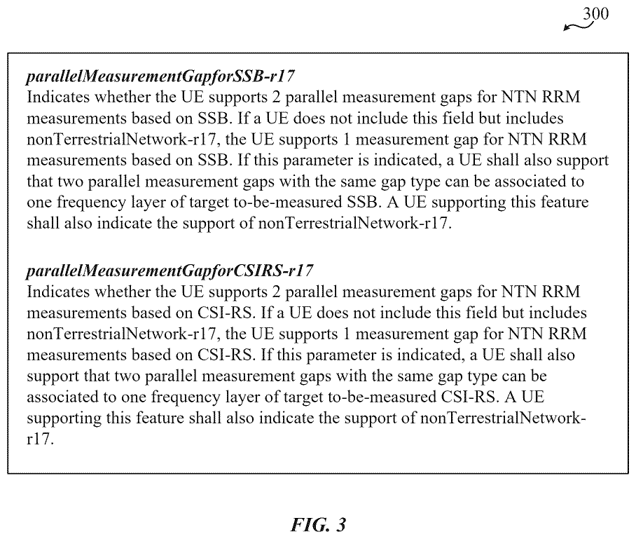

FIG. 3 illustrates an SSB parallel measurement capability parameter (e.g., parallelMeasurementGapforSSB-r17) and a CSI-RS parallel measurement capability parameter (e.g., parallelMeasurementGapforCSIRS-r17) in accordance with some aspects. Separate parameters are used to indicate UE support for parallel measurement gaps for SSB based and CSI-RS based measurements respectively. The SSB parallel measurement capability parameter indicates whether the UE supports two parallel measurement gaps with the same gap type for SSB measurements associated to one frequency layer. The CSI-RS parallel measurement capability parameter indicates whether the UE supports two parallel measurement gaps with the same gap type for CSI-RS measurements associated to one frequency layer. In some aspects, the SSB parallel measurement capability parameter and the CSI-RS parallel measurement capability parameter are included in an IE 300 (e.g., in the UE capability information 204).

In some aspects, two or more SSBs may be considered as associated with the same frequency layer. The SSBs must meet the following criteria to be considered as associated with the same frequency layer: the center SSB of the target cell configured for measurement is the same; and the SSB subcarrier spacing of the target cell configured for measurement is the same. If the SSBs can be considered as associated with the same frequency layer, then the SSBs can be measured using the two parallel measurement gaps associated to the same frequency layer.

In some aspects, two or more CSI-RS may be considered as associated with the same frequency layer. The CSI-RS must meet the following criteria to be considered as associated with the same frequency layer: the subcarrier spacing of the CSI-RS resource of the target cell configured for measurement is the same; the cyclic prefix (CP) type of the CSI-RS resource of the target cell configured for measurement is the same; and the center frequency of the CSI-RS resource of the target cell configured for measurement is the same. If the CSI-RS can be considered as associated with the same frequency layer, then the CSI-RS can be measured using the two parallel measurement gaps associated to the same frequency layer.

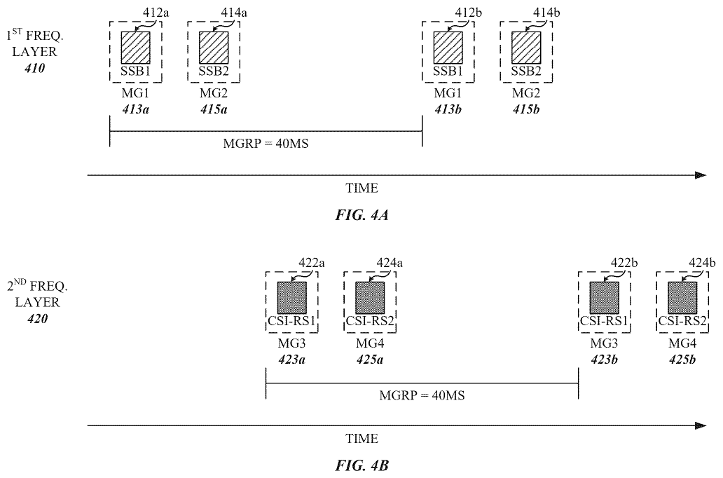

FIGS. 4A-4B illustrate parallel measurement gap configurations in accordance with some aspects. In some aspects, the parallel measurement gaps are configured by a measurement gap configuration (e.g., measurement gap configuration 206).

As illustrated, various measurement repeat periodically in time, and the various occasions may be referred to using the suffixes a, b, etc. For example, a first occasion of a first measurement gap may be referred to as 413a, a second occasion may be referred to as 413b, etc. Similarly, a first occasion of second, third, and fourth measurement gaps may be referred to as 415a, 423a, 425a respectively and a second occasion of the second, third, and fourth measurement gaps may be referred to as 415b, 423b, 425b respectively.

As illustrated, various SSBs and CSI-RS repeat periodically in time. The various occasions may be referred to similarly using suffixes a, b, etc. For example a first occasion of a first SSB and a second SSB may be referred to as 412a and 414a respectively, and a second occasion of the first SSB and the second SSB may be referred to as 412b and 414b respectively. A first occasion of a first CSI-RS and a second CSI-RS may be referred to as 422a and 424a respectively, and a second occasion of the first CSI-RS and the second CSI-RS may be referred to as 422b and 424b respectively.

The first measurement gap 413 may refer to any individual occurrence of the first measurement gap (e.g., 413a or 413b) or all of the occurrences (e.g., 413a and 413b). Similarly the second measurement gap 415, the third measurement gap 423, the fourth measurement gap 425, the first SSB 412, the second SSB 414, the first CSI-RS 422, and the second CSI-RS 424 may be used to refer to any individual or all respective occurrences.

As shown in FIG. 4A, in some aspects, a first set of parallel measurement gaps with a first gap type are configured. In some aspects, an SSB parallel measurement capability parameter (e.g., as described with reference to FIG. 3) indicates that the UE supports two parallel measurement gaps with the same gap type for SSB based measurements associated with one frequency layer.

In some aspects, the first set of parallel measurement gaps includes the first measurement gap 413 and the second measurement gap 415, which are both associated with a first frequency layer 410. The first and second measurement gaps 413, 415 are used to measure the first and second SSBs 412, 414 respectively and share an MGRP. The MGRP is illustrated as 40 ms as a non-limiting example, but may be various other values according to the gap patterns of the measurement gaps 413, 415.

As shown in FIG. 4B, in some aspects, a second set of parallel measurement gaps with a second gap type are configured. In some aspects, a CSI-RS parallel measurement capability parameter (e.g., as described with reference to FIG. 3) indicates that the UE supports two parallel measurement gaps with the same gap type for CSI-RS based measurements associated with one frequency layer. The second set of parallel measurement gaps include the third measurement gap 423 and the fourth measurement gap 425, which are both associated with a second frequency layer 420. The third and fourth measurement gaps 423, 425 are used to measure the first and second CSI-RS 422, 424 respectively and share an MGRP. The MGRP is illustrated as 40 ms, but may be various other values according to the gap pattern of the measurement gaps 423, 425.

In some aspects, the configuration of measurement gaps shown in FIG. 4A and/or FIG. 4B is performed based on UE capability information indicating that the UE supports parallel measurement gaps. For example, the UE may indicate the SSB parallel measurement capability parameter and the CSI-RS parallel measurement capability parameter (e.g., as shown in FIG. 3). In response, a base station may configure the UE for parallel measurement of both SSB and CSI-RS. If the SSB and CSI-RS parallel measurement capability are each indicated individually, the SSB and CSI-RS measurements are considered as associated with different frequency layers (e.g., frequency layers 410, 420) by definition.

In some aspects, FIG. 4A stands alone as an example measurement gap configuration. For example, if the UE supports parallel measurement gaps only for SSB but not for CSI-RS, or if there are no CSI-RS measurements to be performed. Alternatively, if the UE supports parallel measurement gaps for SSB and CSI-RS, and there are CSI-RS measurements to be performed, then the measurement configurations shown FIGS. 4A and 4B may occur simultaneously.

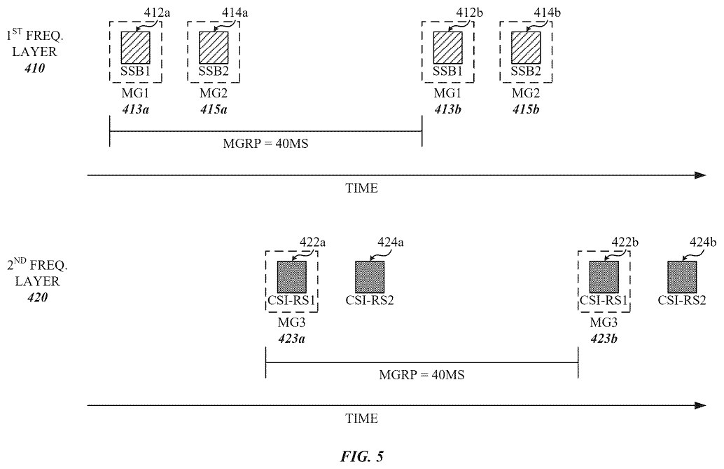

FIG. 5 illustrates a parallel measurement gap configuration in accordance with some aspects. In some aspects, FIG. 5 includes a first frequency layer 410, first and second measurement gaps 413, 415, and first and second SSBs 412, 414 similar to FIG. 4A. In contrast to FIG. 4B, if the UE supports parallel measurement gaps for SSB based measurement (e.g., the UE indicates the SSB parallel measurement capability parameter) but not for CSI-RS based measurements (e.g., the UE does not indicate the CSI-RS parallel measurement capability parameter), parallel measurement gaps are not configured associated with CSI-RS measurements (e.g. shown by the second frequency layer 420). A third measurement gap 423 is configured and used to measure the first CSI-RS 422, but no parallel measurement gap can be configured for another CSI-RS, e.g., the second CSI-RS 424. Thus, the second CSI-RS 424 cannot be measured in a parallel measurement gap as the first CSI-RS 422 even if it is considered as associated with one frequency layer as the first CSI-RS 422.

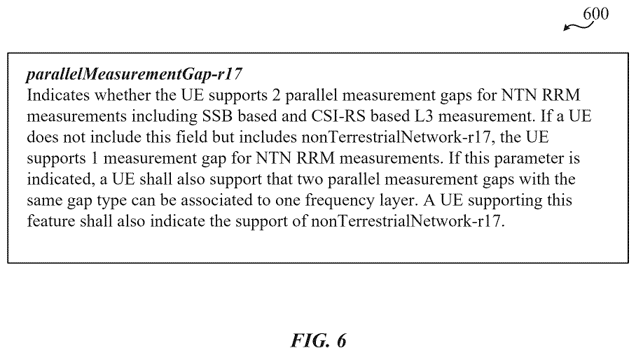

FIG. 6 illustrates a combined parallel measurement capability parameter in accordance with some aspects. In some aspects, the parallel measurement capability is indicated in a combined format for at least both SSB based and CSI-RS based measurements (e.g., as a single parameter parallelMeasurementGap-r17). When the combined parallel measurement capability parameter is indicated, the UE supports two parallel measurement gaps with the same gap type for SSB based and CSI-RS based measurements associated to the same frequency layer. In some aspects, the combined parallel measurement capability parameter is included in an IE 600 (e.g., in the UE capability information 204).

In some aspects, SSBs can be considered as associated to the same frequency layer if they meet the criteria described with reference to FIG. 3. Similarly, CSI-RS can be considered as associated to the same frequency layer if they meet the criteria described with reference to FIG. 3.

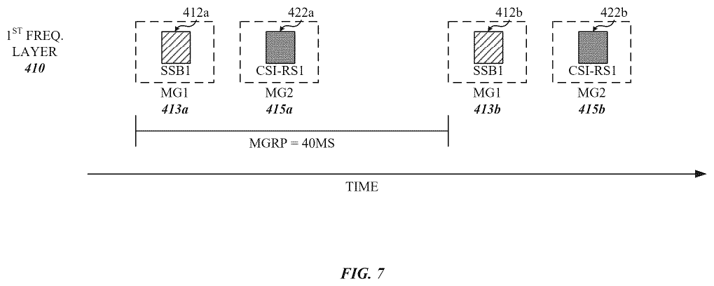

In some aspects, the SSB and the CSI-RS measurements are defined as associated to different frequency layers, and thus cannot be configured with parallel measurement gaps. In some alternative aspects, it is possible for both SSB and CSI-RS measurements to be associated to the same frequency layer. An SSB and a CSI-RS may be considered as associated with the same frequency layer if the SSB is the associated SSB for the CSI-RS. Additionally or alternatively, the SSB and the CSI-RS may be considered as associated with the same frequency layer if the SSB and the CSI-RS are in the same cell carrier. More detailed configuration examples of SSB and CSI-RS being associated to the same frequency layer are described further in this disclosure with reference to FIGS. 7-13.

FIGS. 7-9 illustrate parallel measurement gap configurations in accordance with some aspects. In some aspects, the UE indicates support for two parallel measurement gaps with the same gap type for SSB based and CSI-RS based measurements associated with one frequency layer. The indication may be made by indicating the combined parallel measurement capability parameter. In some aspects, two parallel measurement gaps including a first measurement gap 413 and a second measurement gap 415 are configured within one MGRP.

In some aspects, a first measurement is performed within the first measurement gap 413 and a second measurement is performed within the second measurement gap 415. As shown in FIG. 7, in some aspects, an SSB 412 is measured within the first measurement gap 413, and a CSI-RS 422 is measured within the second measurement gap 415. The SSB 412 and the CSI-RS 422 are both considered as associated with the first frequency layer 410, and meet at least one of the conditions previously described. For example, the SSB 412 may be the associated SSB for the CSI-RS 422, or the SSB 412 and the CSI-RS 422 may be in the same cell carrier.

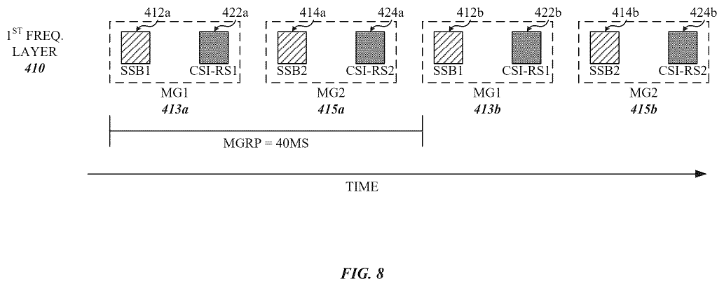

In some aspects, more than one measurement is performed within the first measurement gap 413 and the second measurement gap 415 respectively. As shown in FIG. 8, in some aspects, a first SSB 412 and a first CSI-RS 422 are measured within the first measurement gap 413. A second SSB 414 and a second CSI-RS 424 are measured within the second measurement gap 415. The SSBs 412, 414 and the CSI-RS 422, 424 are all considered as associated with the first frequency layer 410. For example, the SSBs 412, 414 and the CSI-RS 422, 424 may all be in the same cell carrier.

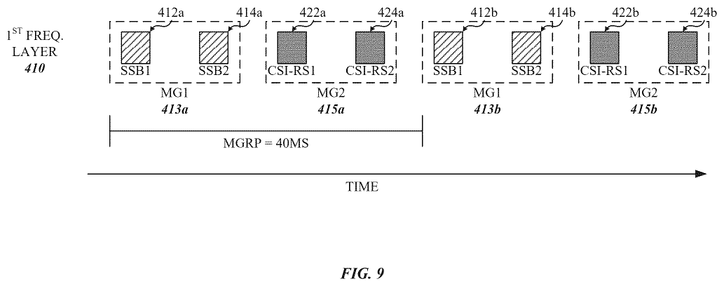

Alternatively, as shown in FIG. 9, the first and second SSBs 412, 414 may be measured within the first measurement gap 413, and the first and second CSI-RS 422, 424 may be measured within the second measurement gap 415. As shown by FIGS. 8-9, the measurements can be configured various ways within the two measurement gaps 413, 415 when the measurements are all associated with the same frequency layer, and the specific measurement configuration depends on how the network configures the UE.

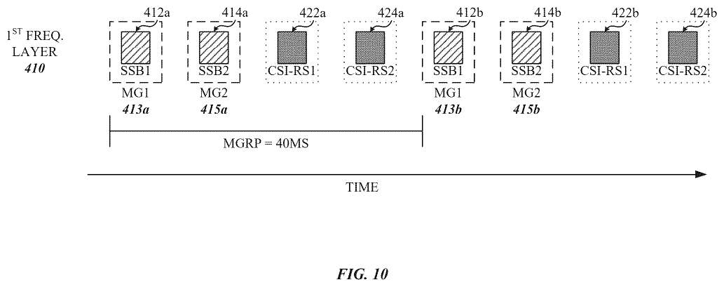

FIGS. 10-12 illustrate measurement gap prioritization in accordance with some aspects. In some aspects, the measurement configuration specifics more parallel measurement gaps than the UE is capable of. For example, the UE is capable of two parallel measurement gaps but four parallel measurement gaps are specified in the measurement configuration. In response, the UE prioritizes measurement gaps based on a priority rule. The UE may choose to prioritize two measurement gaps (e.g., first and second measurement gaps) of the four parallel measurement gaps based on the priority rule, and drop the remaining measurement gaps. In some alternative aspects, the prioritization can be performed at the network side based on the priority rule before sending the measurement configuration, for example, based on UE capability information. Examples of possible priority rules are described with reference to FIGS. 10-13.

As shown by FIG. 10, illustrated are a first measurement gap 413 and a second measurement gap 415 for measurement of a first SSB 412 and a second SSB 414 respectively. The measurement configuration may additionally specify measurement gaps for a first CSI-RS 422 and a second CSI-RS 424 respectively (illustrated as dotted lines). In some aspects, the UE chooses to prioritize the measurement gaps for SSB based measurements (e.g., measurement gaps 413, 415) and drop and not perform CSI-RS based measurements (e.g. the first CSI-RS 422 and the second CSI-RS 424). In some alternative aspects, the prioritization is performed by the network (e.g. the non-terrestrial base station 130). For example, the network may have some knowledge of the UE's capability from the UE capability information, and the prioritization would be triggered at the network side accordingly.

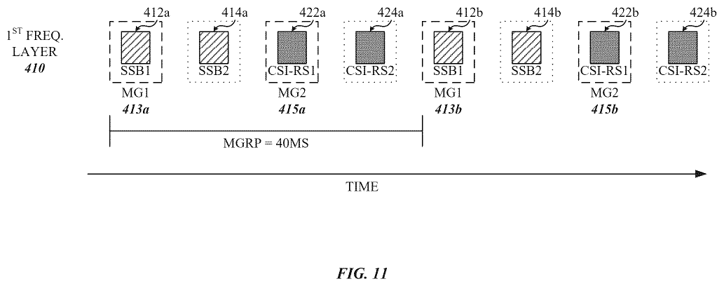

As shown by FIG. 11, illustrated are a first measurement gap 413 and a second measurement gap 415 for measurement of a first SSB 412 and a first CSI-RS 422 respectively. The measurement configuration may additionally specify measurement gaps for a second SSB 414 and a second CSI-RS 424 respectively (illustrated as dotted lines). In some aspects, the UE chooses to prioritize measurement gaps for a first pair of associated SSB and corresponding CSI-RS and drops at least one other measurement gap. In some alternative aspects, the prioritization is done by the network (e.g. the non-terrestrial base station 130). For example, the network may have some knowledge of the UE's capability from the UE capability information, and the prioritization would be triggered at the network side accordingly. In some aspects, the associated SSB and the corresponding CSI-RS may be specified within a measurement object configuration IE as associatedMeasGapSSB-r17 and associatedMeasGapCSIRS-v17 respectively.

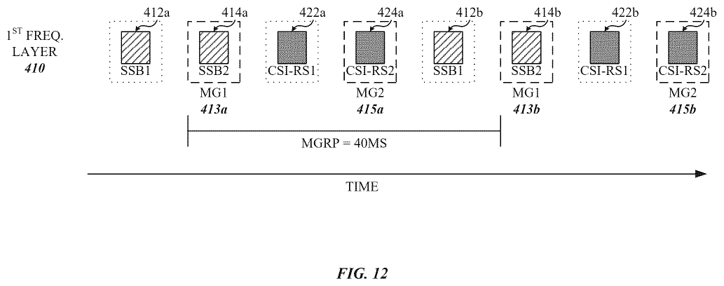

Alternatively, as shown by FIG. 12, the UE may choose to prioritize measurement gaps for a random pair of associated SSB and corresponding CSI-RS. Illustrated are first and second measurement gaps 413, 415 for measurement of a second SSB 414 and a second CSI-RS 424 respectively. The second SSB 414 is the associated SSB for the second CSI-RS 424. Measurement of the second SSB 414 and the second CSI-RS 424 are prioritized over measurement of the first SSB 412 and the first CSI-RS 422. The prioritization may be based on choosing a random pair of associated SSB and corresponding CSI-RS. In some aspects, the first SSB 412 and the first CSI-RS 422 may be specified within a measurement object configuration IE as associatedMeasGapSSB-r17 and associatedMeasGapCSIRS-v17 respectively. The second SSB 414 and the second CSI-RS 424 may be specified within a measurement object configuration IE as associatedMeasGapSSB2-r17xy and associatedMeasGapCSIRS2-v17xy respectively. As illustrated by FIG. 12, based on the random selection, the second pair of associated SSB and corresponding CSI-RS may be selected. Alternatively, the first pair of associated SSB and corresponding CSI-RS may be selected, which results in a measurement gap configuration similar to the configuration illustrated by FIG. 11.

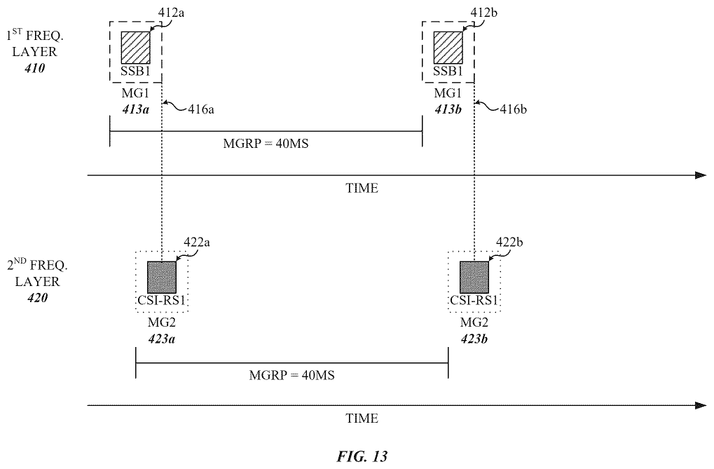

FIG. 13 illustrates measurement gap prioritization in accordance with some aspects. In some aspects a measurement gap for an SSB measurement temporally overlaps a measurement gap for a CSI-RS measurement, and the SSB to be measured is the associated SSB for the CSI-RS to be measured. In response to the SSB being the associated SSB for the CSI-RS, the UE or the network prioritizes the measurement gap for the SSB measurement.

For example, a first measurement gap 413 is configured for measurement of an SSB 412 associated to a first frequency layer 410. A second measurement gap 423 is configured for measurement of a CSI-RS 422 associated to a second frequency layer 420. The first and second measurement gaps 413, 423 temporally overlap. Since a temporal end 416 of the first measurement gap 413 temporally overlaps with the second measurement gap 423, the first and second measurement gaps 413, 423 are temporally colliding.

The SSB 412 is the associated SSB for the CSI-RS 422. The UE prioritizes configuring the first measurement gap 413 for measurement of the SSB 412 while ignoring a measurement gap priority from the network (e.g., a priority specified in the measurement configuration).

In some alternative aspects, the prioritization is done by the network (e.g. the non-terrestrial base station 130). For example, the network may always configure a higher priority for the measurement gap 413 for the SSB 412 than the measurement gap 423 for the CSI-RS 422 when the SSB 412 is the associated SSB for the corresponding CSI-RS 422.

Although the first and second measurement gaps 413, 423 are illustrated as colliding while being associated to different frequency layers, it is appreciated that similar techniques could be applied in scenarios where first and second measurement gaps 413, 423 are associated to the same frequency layer. The first and second measurement gaps 413, 423 are merely illustrated as associated to different frequency layers for simplicity.

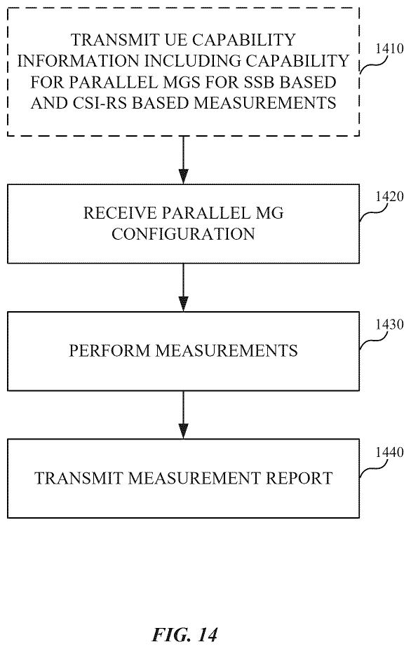

FIG. 14 is a process flow for a UE to perform measurements using parallel measurement gaps in accordance with some aspects. In some optional aspects, at act 1410 the UE transmits UE capability information to a non-terrestrial base station. The UE capability information may be the UE capability information previously described, and may indicate UE capability for two parallel measurement gaps (MGs) of the same gap type associated to the same frequency layer. The capability may be indicated jointly (e.g., a combined parallel measurement capability parameter) or individually (e.g., an SSB parallel measurement capability parameter and a CSI-RS parallel measurement capability parameter). At act 1420, the UE receives a parallel MG configuration. At act 1430, the UE performs the configured measurements and at act 1440 the UE transmits a measurement report to the non-terrestrial base station including the results of the performed measurements.

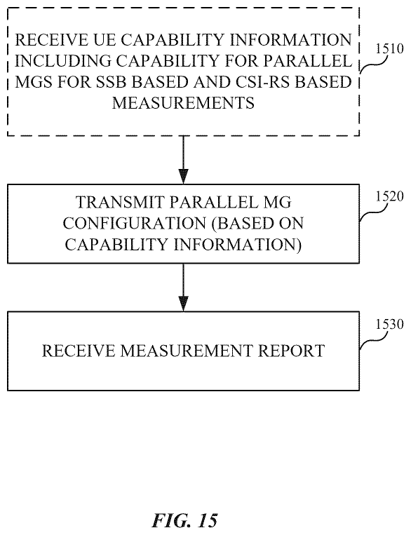

FIG. 15 is a process flow for a base station to configure a UE for measurement using parallel measurement gaps in accordance with some aspects. In some aspects, the base station is a non-terrestrial base station. In some optional aspects, at act 1510, the base station receives UE capability information from a UE. The UE capability information may be the UE capability information previously described, and may indicate UE capability for two parallel MGs of the same gap type associated to the same frequency layer. The capability may be indicated jointly (e.g., a combined parallel measurement capability parameter) or individually (e.g., an SSB parallel measurement capability parameter and a CSI-RS parallel measurement capability parameter). At act 1520, the base station transmits an MG configuration to the UE to configure parallel MGs. In some aspects, if the base station received the UE capability information at act 1510, the measurement configuration may be determined based on the UE capability information. For example, the measurement configuration may only configure measurement gaps within the capability of the UE based on priority rules. At act 1530, the base station receives a measurement report from the UE containing results of the measurements.

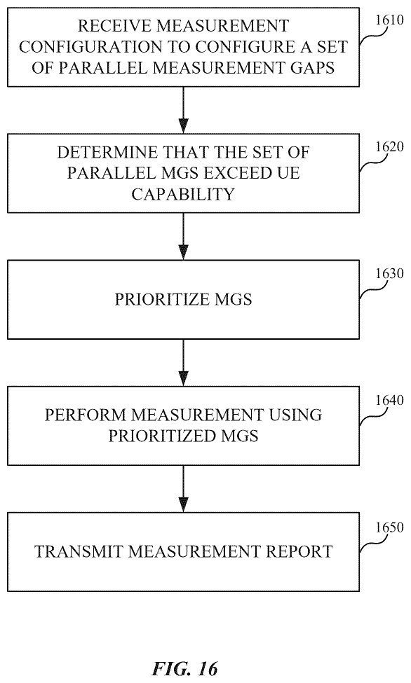

FIG. 16 is a process flow for a UE to perform measurement gap prioritization for parallel measurement gaps in accordance with some aspects. In some aspects, at act 1610 the UE receives a measurement configuration to configure a set of parallel MGs. At act 1620, the UE determines that the set of parallel MGs exceeds a capability of the UE. At act 1630, the UE prioritizes MGs, which may be performed according to one of the various MG prioritization rules previously described. At act 1640, the UE performs measurements using the prioritized MGs and transmits a measurement report at act 1650 including results of the performed measurements.

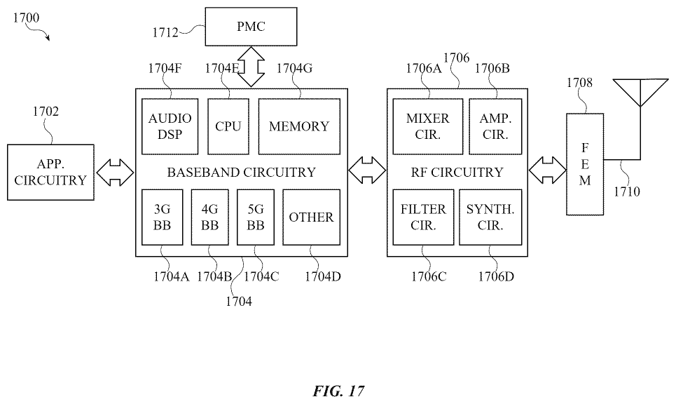

FIG. 17 is a diagram illustrating example components of a device 1700 that can be employed in accordance with some aspects. In some aspects, the device 1700 can include application circuitry 1702, baseband circuitry 1704, Radio Frequency (RF) circuitry 1706, front-end module (FEM) circuitry 1708, one or more antennas 1710, and power management circuitry (PMC) 1712 coupled together at least as shown. The components of the illustrated device 1700 can be included in a UE, a RAN node, or a satellite such as the UE 101, the BS 111, or the NT-BS 130 as described, for example, with reference to FIGS. 1-2 and throughout the present disclosure. The UE 101 and the NT-BS 130 may be configured to utilize parallel measurement gaps for SSB based and CSI-RS based measurements, as described throughout the present disclosure. In some implementations, the device 1700 can include fewer elements (e.g., a RAN node may not utilize application circuitry 1702 and instead include a processor/controller to process IP data received from a CN, which may be a 5GC or an Evolved Packet Core (EPC)). In some implementations, the device 1700 can include additional elements such as, for example, memory/storage, display, camera, sensor (including one or more temperature sensors, such as a single temperature sensor, a plurality of temperature sensors at different locations in device 1700, etc.), or input/output (I/O) interface. In other implementations, the components described below can be included in more than one device (e.g., said circuitries can be separately included in more than one device for Cloud-RAN (C-RAN) implementations).

The application circuitry 1702 can include one or more application processors. For example, the application circuitry 1702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1700. In some implementations, processors of application circuitry 1702 can process IP data packets received from an EPC.

The baseband circuitry 1704 can include circuitry such as, but not limited to, one or more single-core or multi-core processors. The baseband circuitry 1704 can include one or more baseband processors or control logic to process baseband signals received from a receive signal path of the RF circuitry 1706 and to generate baseband signals for a transmit signal path of the RF circuitry 1706. Baseband circuitry 1704 can interface with the application circuitry 1702 for generation and processing of the baseband signals and for controlling operations of the RF circuitry 1706. For example, in some implementations, the baseband circuitry 1704 can include a third generation (3G) baseband processor 1704A, a fourth generation (4G) baseband processor 1704B, a fifth generation (5G) baseband processor 1704C, or other baseband processor(s) 1704D for other existing generations, generations in development or to be developed in the future (e.g., second generation (2G), sixth generation (6G), etc.). The baseband circuitry 1704 (e.g., one or more of baseband processors 1704A-D) can handle various radio control functions that enable communication with one or more radio networks via the RF circuitry 1706. In other implementations, some or all of the functionality of baseband processors 1704A-D can be included in modules stored in the memory 1704G and executed via a Central Processing Unit (CPU) 1704E. The radio control functions can include but are not limited to signal modulation/demodulation, encoding/decoding, radio frequency shifting, etc. In some implementations, modulation/demodulation circuitry of the baseband circuitry 1704 can include Fast-Fourier Transform (FFT), precoding, or constellation mapping/demapping functionality. In some implementations, encoding/decoding circuitry of the baseband circuitry 1704 can include convolution, tail-biting convolution, turbo, Viterbi, or Low Density Parity Check (LDPC) encoder/decoder functionality. Implementations of modulation/demodulation and encoder/decoder functionality are not limited to these examples and can include other suitable functionality in other implementations.

In some implementations, the baseband circuitry 1704 can include one or more audio digital signal processor(s) (DSP) 1704F. The audio DSP(s) 1704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1704 and the application circuitry 1702 can be implemented together such as, for example, on a system on a chip (SOC).

In some implementations, the baseband circuitry 1704 can provide for communication compatible with one or more radio technologies. For example, in some implementations, the baseband circuitry 1704 can support communication with an NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1704 is configured to support radio communications of more than one wireless protocol can be referred to as multi-mode baseband circuitry.

RF circuitry 1706 can enable communication with wireless networks using modulated electromagnetic radiation through a non-solid medium. In various implementations, the RF circuitry 1706 can include switches, filters, amplifiers, etc., to facilitate communication with the wireless network. RF circuitry 1706 can include a receive signal path which can include circuitry to down-convert RF signals received from the FEM circuitry 1708 and provide baseband signals to the baseband circuitry 1704. RF circuitry 1706 can also include a transmit signal path which can include circuitry to up-convert baseband signals provided by the baseband circuitry 1704 and provide RF output signals to the FEM circuitry 1708 for transmission.

In some implementations, the receive signal path of the RF circuitry 1706 can include mixer circuitry 1706A, amplifier circuitry 1706B, and filter circuitry 1706C. In some implementations, the transmit signal path of the RF circuitry 1706 can include filter circuitry 1706C and mixer circuitry 1706A. RF circuitry 1706 can also include synthesizer circuitry 1706D for synthesizing a frequency for use by the mixer circuitry 1706A of the receive signal path and the transmit signal path. In some implementations, the mixer circuitry 1706A of the receive signal path can be configured to down-convert RF signals received from the FEM circuitry 1708 based on the synthesized frequency provided by synthesizer circuitry 1706D. The amplifier circuitry 1706B can be configured to amplify the down-converted signals, and the filter circuitry 1706C can be a low-pass filter (LPF) or band-pass filter (BPF) configured to remove unwanted signals from the down-converted signals to generate output baseband signals. Output baseband signals can be provided to the baseband circuitry 1704 for further processing. In some implementations, the output baseband signals can be zero-frequency baseband signals, although this is not a requirement. In some implementations, mixer circuitry 1706A of the receive signal path can comprise passive mixers, although the scope of the implementations is not limited in this respect.

In some implementations, the mixer circuitry 1706A of the transmit signal path can be configured to up-convert input baseband signals based on the synthesized frequency provided by the synthesizer circuitry 1706D to generate RF output signals for the FEM circuitry 1708. The baseband signals can be provided by the baseband circuitry 1704 and can be filtered by filter circuitry 1706C.

In some implementations, the mixer circuitry 1706A of the receive signal path and the mixer circuitry 1706A of the transmit signal path can include two or more mixers and can be arranged for quadrature downconversion and upconversion, respectively. In some implementations, the mixer circuitry 1706A of the receive signal path and the mixer circuitry 1706A of the transmit signal path can include two or more mixers and can be arranged for image rejection (e.g., Hartley image rejection). In some implementations, the mixer circuitry 1706A of the receive signal path and the mixer circuitry 1706A can be arranged for direct downconversion and direct upconversion, respectively. In some implementations, the mixer circuitry 1706A of the receive signal path and the mixer circuitry 1706A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1706 can include analog-to-digital converter (ADC) and digital-to-analog converter (DAC) circuitry, and the baseband circuitry 1704 can include a digital baseband interface to communicate with the RF circuitry 1706.

In some dual-mode implementations, a separate radio IC circuitry can be provided for processing signals for each spectrum, although the scope of the implementations is not limited in this respect.

In some implementations, the synthesizer circuitry 1706D can be a fractional-N synthesizer or a fractional N/N+1 synthesizer, although the scope of the implementations is not limited in this respect as other types of frequency synthesizers can be suitable. For example, synthesizer circuitry 1706D can be a delta-sigma synthesizer, a frequency multiplier, or a synthesizer comprising a phase-locked loop with a frequency divider.

The synthesizer circuitry 1706D can be configured to synthesize an output frequency for use by the mixer circuitry 1706A of the RF circuitry 1706 based on a frequency input and a divider control input. In some implementations, the synthesizer circuitry 1706D can be a fractional N/N+1 synthesizer.

In some implementations, frequency input can be provided by a voltage-controlled oscillator (VCO), although that is not a requirement. Divider control input can be provided by either the baseband circuitry 1704 or the application circuitry 1702, depending on the desired output frequency. In some implementations, a divider control input (e.g., N) can be determined from a look-up table based on a channel indicated by the application circuitry 1702.

Synthesizer circuitry 1706D of the RF circuitry 1706 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump, and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (ILO). In some implementations, the RF circuitry 1706 can include an IQ/polar converter.

FEM circuitry 1708 can include a receive signal path which can include circuitry configured to operate on RF signals received from one or more antennas 1710, amplify the received signals and provide the amplified versions of the received signals to the RF circuitry 1706 for further processing. FEM circuitry 1708 can also include a transmit signal path which can include circuitry configured to amplify signals for transmission provided by the RF circuitry 1706 for transmission by one or more of the one or more antennas 1710. In various implementations, the amplification through the transmit or receive signal paths can be done solely in the RF circuitry 1706, solely in the FEM circuitry 1708, or in both the RF circuitry 1706 and the FEM circuitry 1708.

In some implementations, the FEM circuitry 1708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1706). The transmit signal path of the FEM circuitry 1708 can include a power amplifier (PA) to amplify input RF signals (e.g., provided by RF circuitry 1706), and one or more filters to generate RF signals for subsequent transmission (e.g., by one or more of the one or more antennas 1710).

In some implementations, the PMC 1712 can manage power provided to the baseband circuitry 1704. In particular, the PMC 1712 can control power-source selection, voltage scaling, battery charging, or DC-to-DC conversion. The PMC 1712 can often be included when the device 1700 is capable of being powered by a battery, for example, when the device is included in a UE. The PMC 1712 can increase the power conversion efficiency while providing desirable implementation size and heat dissipation characteristics.

While FIG. 17 shows the PMC 1712 coupled only with the baseband circuitry 1704, in other implementations, the PMC 1712 may be additionally or alternatively coupled with, and perform similar power management operations for, other components such as, but not limited to, application circuitry 1702, RF circuitry 1706, or FEM circuitry 1708.

In some implementations, the PMC 1712 can control, or otherwise be part of, various power saving mechanisms of the device 1700. For example, if the device 1700 is in an RRC_Connected state, where it is still connected to the RAN node as it expects to receive traffic shortly, then it can enter a state known as Discontinuous Reception Mode (DRX) after a period of inactivity. During this state, the device 1700 can power down for brief intervals of time and thus save power.

If there is no data traffic activity for an extended period of time, then the device 1700 can transition off to an RRC_Idle state, where it disconnects from the network and does not perform operations such as channel quality feedback, handover, etc. The device 1700 goes into a very low power state and it performs paging where again it periodically wakes up to listen to the network and then powers down again. The device 1700 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 1702 and processors of the baseband circuitry 1704 can be used to execute elements of one or more instances of a protocol stack. For example, processors of the baseband circuitry 1704, alone or in combination, can be used execute Layer 3, Layer 2, or Layer 1 functionality, while processors of the baseband circuitry 1704 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a PDCP layer, described in further detail below. As referred to herein, Layer 1 can comprise a physical (PHY) layer of a UE/RAN node, described in further detail below.

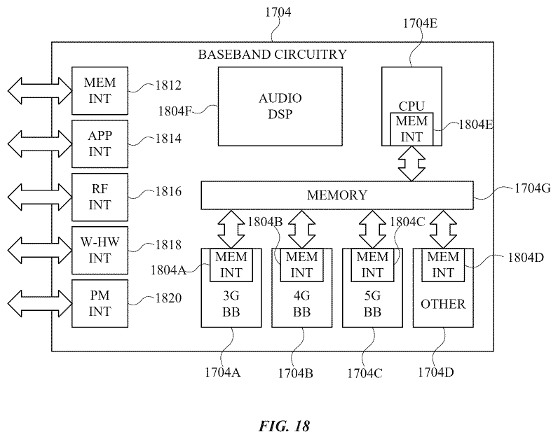

FIG. 18 illustrates a diagram illustrating example interfaces of baseband circuitry that can be employed in accordance with some aspects. As discussed above, the baseband circuitry 1704 of FIG. 17 can comprise processors 1704A-1704E and a memory 1704G utilized by said processors. Each of the processors 1704A-1704E can include a memory interface, 1804A-1804E, respectively, to send/receive data to/from the memory 1704G. The baseband circuitry 1704, or the one or more baseband processors or control logic of the baseband circuitry 1704, may stand alone as the UE 101, the base station 111, or the NT-BS 130 and perform signaling and operation in the meaning as described throughout this disclosure.

The baseband circuitry 1704 can further include one or more interfaces to communicatively couple to other circuitries/devices, such as a memory interface 1812 (e.g., an interface to send/receive data to/from memory external to the baseband circuitry 1704), an application circuitry interface 1814 (e.g., an interface to send/receive data to/from the application circuitry 1702 of FIG. 17), an RF circuitry interface 1816 (e.g., an interface to send/receive data to/from RF circuitry 1706 of FIG. 17), a wireless hardware connectivity interface 1818 (e.g., an interface to send/receive data to/from Near Field Communication (NFC) components, Bluetooth® components (e.g., Bluetooth® Low Energy), Wi-Fi® components, and other communication components), and a power management interface 1820 (e.g., an interface to send/receive power or control signals to/from the PMC 1712).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a User Equipment (UE) comprising a memory and a processor coupled to the memory and configured to execute instructions stored in the memory to cause the UE to: transmit UE capability information to a serving cell, the UE capability information comprising a channel state information reference signal (CSI-RS) parallel measurement capability parameter, wherein the CSI-RS parallel measurement capability parameter indicates that the UE is capable of performing two CSI-RS based measurements using two parallel measurement gaps (MGs), receive a measurement configuration to configure the two parallel MGs including a first MG and a second MG, and perform the two CSI-RS based measurements including a first CSI-RS based measurement and a second CSI-RS based measurement within the first MG and the second MG respectively.

Example 2 comprises any variation of the subject matter of claim 1, wherein the two CSI-RS based measurements are associated with a first frequency layer.

Example 3 comprises any variation of the subject matter of claim 2, wherein the first CSI-RS based measurement and the second CSI-RS based measurement are determined to be associated with the first frequency layer in response to a CSI-RS resource associated with the first CSI-RS measurement and a CSI-RS resource associated with the second CSI-RS based measurement having a same subcarrier spacing, a same cyclic prefix (CP), and a same center frequency.

Example 4 comprises any variation of the subject matter of claim 1, wherein the UE capability information further comprises a synchronization signal block (SSB) parallel measurement capability parameter.

Example 5 comprises any variation of the subject matter of claim 1, wherein the two parallel MGs have a same gap type and a same measurement gap repetition period (MGRP).

Example 6 comprises any variation of the subject matter of claim 1, wherein the serving cell is a non-terrestrial serving cell.

Example 7 is a baseband processor of a User Equipment (UE). The baseband processor is configured to: transmit UE capability information to a serving cell, the UE capability information comprising a combined parallel measurement capability parameter indicating that the UE is capable of performing synchronization signal block (SSB) based measurements and channel state information reference signal (CSI-RS) based measurements using two parallel measurement gaps (MGs), receive a measurement configuration to configure the two parallel MGs including a first MG and a second MG, and perform a first measurement and a second measurement using the first and second MGs.

Example 8 comprises any variation of the subject matter of example 7, wherein the SSB based measurements and the CSI-RS based measurements are associated with a first frequency layer.

Example 9 comprises any variation of the subject matter of example 8, wherein the first measurement is an SSB based measurement, and wherein the second measurement is a CSI-RS based measurement.

Example 10 comprises any variation of the subject matter of example 9, wherein the SSB based measurement and the CSI-RS based measurement are determined to be associated with the first frequency layer in response to an SSB of the SSB based measurement being an associated SSB for the CSI-RS based measurement.

Example 11 comprises any variation of the subject matter of example 9, wherein the SSB based measurement and the CSI-RS based measurement are determined to be associated with the first frequency layer in response to the SSB based measurement and the CSI-RS based measurement being in the same cell carrier.

Example 12 comprises any variation of the subject matter of example 7, wherein the two parallel MGs have a same gap type and a same measurement gap repetition period (MGRP).

Example 13 comprises any variation of the subject matter of example 7, wherein the first and second measurements are SSB based measurements, wherein the measurement configuration further configures a third MG for a CSI-RS based measurement, and wherein the SSB based measurements and the CSI-RS based measurement are defined as associated with different frequency layers.

Example 14 comprises any variation of the subject matter of example 7, wherein the first and second measurements are SSB based measurements, wherein the measurement configuration further configures a third MG for a CSI-RS based measurement, and wherein the baseband processor is further configured to: ignore a priority of the first MG and the third MG from the measurement configuration and prioritize the first MG over the third MG, wherein an SSB of the first measurement is an associated SSB for the CSI-RS based measurement, and wherein the first MG and the third MG overlap temporally.

Example 15 is a baseband processor of a base station. The baseband processor is configured to: receive User Equipment (UE) capability information from a UE, the UE capability information comprising a combined parallel measurement capability parameter indicating that the UE is capable of performing synchronization signal block (SSB) based measurements and channel state information reference signal (CSI-RS) based measurements using two parallel measurement gaps (MGs), transmit a measurement configuration to the UE to configure the two parallel MGs to be used for first and second measurements, and receive a measurement report from the UE including results of the first and second measurements.

Example 16 comprises any variation of the subject matter of example 15, wherein the measurement configuration is based on the UE capability information.

Example 17 comprises any variation of the subject matter of example 15, wherein the first and second measurements are SSB based measurements, and wherein the MGs for SSB based measurements are prioritized to be configured over MGs for CSI-RS based measurements.

Example 18 comprises any variation of the subject matter of example 17, wherein the prioritization is performed in response to one of the two parallel MGs temporally overlapping a third MG for a CSI-RS based measurement, and wherein an SSB of the first measurement or an SSB of the second measurement is an associated SSB for the CSI-RS based measurement.

Example 19 comprises any variation of the subject matter of example 17, wherein the prioritization is performed in response to a number of MGs exceeding a capability of the UE as indicated in the UE capability information.

Example 20 comprises any variation of the subject matter of example 15, wherein the first measurement is an SSB based measurement, wherein the second measurement is a CSI-RS based measurement, wherein an SSB of the SSB based measurement is an associated SSB for the CSI-RS based measurement.

Example 21 comprises any variation of the subject matter of example 15, wherein the base station is a non-terrestrial base station.

Example 22 comprises any variation of the subject matter of example 15, wherein the SSB based measurements and the CSI-RS based measurements are associated with a first frequency layer.

Example 23 comprises any variation of the subject matter of example 15, wherein the two parallel MGs have a same gap type and a same measurement gap repetition period (MGRP).

Example 24 is a User Equipment (UE) comprising a memory and a processor coupled to the memory and configured to executed instructions stored in the memory to cause the UE to: receive a measurement configuration from a non-terrestrial base station to configure a set of parallel measurement gaps (MGs) for synchronization signal block (SSB) based measurements and channel state information reference signal (CSI-RS) based measurements, determine that the set of parallel MGs exceed a parallel gap measurement capability of the UE, prioritize a first MG and a second MG of the set of parallel MGs based on a priority rule, and perform a first measurement and a second measurement associated with the prioritized first and second MGs, and drop by not performing measurements associated with remaining MGs of the set of parallel MGs.

Example 25 comprises any variation of the subject matter of example 24, wherein the first and second MGs are both associated with SSB based measurements, and wherein the first and second MGs are prioritized over MGs for CSI-RS based measurements.

Example 26 comprises any variation of the subject matter of example 24, wherein the first MG is for an SSB based measurement, wherein the second MG is for a CSI-RS based measurement, and wherein an SSB of the SSB based measurement is an associated SSB for the CSI-RS based measurement.

Example 27 comprises any variation of the subject matter of example 24, wherein the first MG and the second MG are specified in a measurement object configuration information element (IE) by associatedMeasGapSSB-r17 and associatedMeasGapCSIRS-v17 respectively. Example 28 comprises any variation of the subject matter of example 26, wherein the first MG and the second MG are prioritized over a third MG and a fourth MG specified in the measurement object configuration IE by associatedMeasGapSSB2-r17xy and associatedMeasGapCSIRS2-v17xy respectively, and wherein the priority rule includes choosing a random pair of measurement gaps for CSI-RS measurement and the associated SSB measurement.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A User Equipment (UE), comprising:
radio frequency (RF) circuitry;
a memory; and
a processor coupled to the memory and configured to execute instructions stored in the memory to cause the UE to:
transmit, via the RF circuitry, UE capability information comprising a synchronization signal block (SSB) parallel measurement capability parameter indicating
that the UE is capable of performing two SSB based measurements using two parallel measurement gaps (MGs);
receive a measurement configuration to configure the two parallel MGs including a first MG and a second MG; and
perform the two SSB based measurements including a first SSB based measurement and a second SSB based measurement within the first MG and the second MG respectively.

2. The UE of claim 1, wherein the two SSB based measurements are associated with a first frequency layer.

3. The UE of claim 2, wherein the first SSB based measurement and the second SSB based measurement are determined to be associated with the first frequency layer in response to a center SSB of a target cell configured for measurement being the same, and an SSB subcarrier spacing of the target cell configured for measurement being the same.

4. The UE of claim 1, wherein the UE capability information further comprises a channel state information reference signal (CSI-RS) parallel measurement capability parameter indicating whether the UE is capable of performing two CSI-RS based measurements using two parallel MGs.

5. The UE of claim 1, wherein the two parallel MGs have a same gap type.

6. The UE of claim 1, wherein the UE capability information is transmitted to a non-terrestrial serving cell, and wherein the two SSB based measurements comprise non-terrestrial network (NTN) measurements.

7. A baseband processor configured to, when executing instructions stored in a memory, perform operations comprising:
providing, to a radio frequency (RF) interface for transmission, User Equipment (UE) capability information comprising a synchronization signal block (SSB) parallel measurement capability parameter indicating that the UE is capable of performing SSB based measurements using two parallel measurement gaps (MGs);
receiving a measurement configuration to configure the two parallel MGs including a first MG and a second MG; and
performing a first SSB based measurement and a second SSB based measurement using the first and second MGs.

8. The baseband processor of claim 7, wherein the first and second SSB based measurements are associated with a first frequency layer.

9. The baseband processor of claim 7, wherein the UE capability information is included in a MeasAndMobParameters information element (IE).

10. (canceled)

11. The baseband processor of claim 7, wherein the two parallel MGs have a same gap type.

12. The baseband processor of claim 7, wherein the two parallel MGs have a same measurement gap repetition period (MGRP).

13. The baseband processor of claim 7, wherein the measurement configuration further configures a third MG for a channel state information reference signal (CSI-RS) based measurement, and wherein the SSB based measurements and the CSI-RS based measurement are defined as associated with different frequency layers.

14. The baseband processor of claim 7, wherein the measurement configuration further configures a third MG for a channel state information reference signal (CSI-RS) based measurement, and wherein the operations further comprise:
ignoring a priority of the first MG and the third MG from the measurement configuration and prioritize the first MG over the third MG;
wherein an SSB of the first SSB measurement is an associated SSB for the CSI-RS based measurement; and
wherein the first MG and the third MG overlap temporally.

15. A baseband processor configured to, when executing instructions stored in a memory, perform operations comprising:
receiving, from a User Equipment (UE), UE capability information comprising a synchronization signal block (SSB) parallel measurement capability parameter indicating that the UE is capable of performing SSB based measurements using two parallel measurement gaps (MGs);
providing, to a radio frequency (RF) interface for transmission to the UE, a measurement configuration to configure the two parallel MGs to be used for a first measurement and a second measurement; and
receiving a measurement report from the UE including results of the first and second measurements.

16. The baseband processor of claim 15, wherein the operations further comprise providing the measurement configuration based on the UE capability information.

17. The baseband processor of claim 15, wherein the first and second measurements are SSB based measurements, and wherein the MGs for SSB based measurements are prioritized to be configured over MGs for channel state information reference signal (CSI-RS) based measurements.

18. The baseband processor of claim 17, wherein the prioritization is performed in response to one of the two parallel MGs temporally overlapping a third MG for a CSI-RS based measurement, and wherein an SSB of the first measurement or an SSB of the second measurement is an associated SSB for the CSI-RS based measurement.

19. The baseband processor of claim 17, wherein the prioritization is performed in response to a number of MGs exceeding a capability of the UE as indicated in the UE capability information.

20-21. (canceled)

22. The baseband processor of claim 15, wherein the first and second measurements are associated with a first frequency layer.

23. The baseband processor of claim 15, wherein the two parallel MGs have a same gap type and a same measurement gap repetition period (MGRP).

24-28. (canceled)
